(19) United States
(12) Patent Application Publication
(10) Pub. No.: US 2010/0212358 A1
(43) Pub. Date: Aug. 26, 2010

(54) GLASS SUBSTRATE ORIENTATION INSPECTION METHODS AND SYSTEMS FOR PHOTO VOLTAICS PRODUCTION

(75) Inventors: DHRUV GAJARIA, Sunnyvale, CA (US); Hanzhong Zhang, Cupertino, CA (US); Richard Hong, San Jose, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/393,875

(22) Filed: Feb. 26, 2009

(51) Int. Cl. C03B 20/00

(52) U.S. Cl. 65/29.12; 65/158

(57) ABSTRACT

The present disclosure relates to methods for automated inspection of the orientation of a glass substrate (100) having a side that is coated and/or impregnated with a non-glass material (e.g., tin). One method (40) includes: picking up the glass substrate (100) by using an automatic lifting assembly (98); inspecting a side of the glass substrate (100) with a sensor (92) so as to determine whether the inspected side is coated or impregnated with the non-glass material; determining whether the glass substrate (100) is correctly oriented based upon the inspection results; and using the automated lifting assembly (98) to place the glass substrate (100) on a conveyor (94) in response to determining that the glass substrate (100) is correctly oriented.

### BACKGROUND

Various embodiments described herein relate generally to methods and systems for automated inspection of the orientation of a glass substrate having a side that is coated and/or impregnated with a non-glass material. These methods can be particularly effective for ensuring the correct orientation of tin coated and/or impregnated glass substrates used in the formation of some thin-film solar cells.

Current methods for forming thin-film solar cells involve depositing or otherwise forming a plurality of layers on a substrate, such as a glass, metal or polymer substrate suitable to form one or more p-n junctions. An exemplary thin-film solar cell includes a glass substrate having a transparent conductive oxide (TCO) layer, a plurality of doped and undoped silicon layers, and a metal back layer. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference.

Some glass substrates used to form thin-film solar cells include a tin coated and/or impregnated side and a non-tin coated and/or impregnated side. FIG. 1A illustrates a glass substrate 10 that includes a glass layer 12 and a tin coated and/or impregnated layer 14. As will be described below (FIG. 1C), glass substrate 10 can be used as a “back” glass for a thin-film solar cell. FIG. 1B illustrates a “front” glass substrate 20 that includes a glass layer 22, a tin coated and/or impregnated layer 24, and a TCO layer 26. The front glass substrate 20 can be formed from a tin coated and/or impregnated glass substrate (e.g., glass substrate 10 of FIG. 1A) by forming TCO layer 26 on the non-tin coated and/or impregnated side.

FIG. 1C illustrates an exemplary thin-film solar cell 30 that includes a back glass substrate 10 and a front glass substrate 20. The formation of solar cell 30 includes laser-scribing of the TCO layer 26 of the front glass substrate 20 so as to isolate TCO layer regions from each other. A plurality of doped and undoped silicon layers 32 are then deposited, which are also laser-scribed to isolate silicon layers 32 from each other. A metal layer 34 is then deposited, which is also laser scribed to isolate metal layer regions from each other. A sealant layer 36, such as polyvinyl butyral (PVB), is then applied and the back glass 10 is laminated in place by way of sealant layer 36.

Both the front glass substrate 20 and the back glass substrate 10 are oriented so that their tin coated and/or impregnated layers 24, 14 are facing outwards. If a tin coated and/or impregnated layer is incorrectly oriented (i.e., with a tin layer facing inwards), there is a concern that the tin may migrate into the solar cell over time and degraded the performance of the solar cell. If the TCO layer is deposited on the tin layer it will have a negative influence on the coating process and the tin layer may be absorbed into subsequent processing steps leading to inefficiencies. Accordingly, it is desirable that the front and back glass substrates be properly oriented during manufacturing. However, the tin layers 14, 24 are not readily discernible with the naked eye. As a result, whether the back glass substrate 10 is properly oriented is not visually apparent. Additionally, whether the front glass substrate 20 is properly oriented prior to the formation of the TCO layer 26 is also not visually apparent.

Accordingly, it is desirable to develop methods and systems for inspection of the orientation of glass substrates having a side that is coated and/or impregnated with a non-glass material. More particularly, it is desirable to develop methods and systems for ensuring the correct orientation of tin coated and/or impregnated glass substrates used in the formation of some thin-film solar cells.

### BRIEF SUMMARY

Methods and systems in accordance with various aspects and embodiments are provided for automated inspection of the orientation of a glass substrate having a side that is coated and/or impregnated with a non-glass material (e.g., tin). Such methods and systems can be particularly effective when used to ensure the orientation of tin coated and/or impregnated glass substrates used in the formation of thin-film solar cells. The proper orientation of such glass substrates may inhibit potential migration of the non-glass material (e.g., tin). For example, by ensuring the proper orientation of tin coated and/or impregnated glass substrates used in some thin-film solar cells any performance degradation associated with migration of tin into the solar cell may be reduced or eliminated.

The following presents a simplified summary of some embodiments of the invention in order to provide a basic understanding of the invention. This summary is not an extensive overview of the invention. Its purpose is to present some aspects and embodiments of the invention in summary form.

Methods are provided for automated inspection of the orientation of a glass substrate having a first side and a second side, wherein the glass substrate includes a first material that coats or impregnates the first side. A method includes picking up the glass substrate by using a automated lifting assembly, inspecting a side of the glass substrate with a sensor so as to determine whether the inspected side is the first side or the second side, determining whether the glass substrate is correctly oriented based upon whether the inspected side is the first side or the second side, and using the automated lifting assembly to place the glass substrate on a conveyor in response to determining that the glass substrate is correctly oriented. Another method includes placing the glass substrate on a conveyor, inspecting a side of the glass substrate with a sensor so as to determine whether the inspected side is the first side or the second side, wherein the sensor is coupled with the conveyor, determining whether the glass substrate is correctly oriented based upon whether the inspected side is the first side or the second side, and removing the glass substrate from the conveyor in response to determining that the glass substrate is incorrectly oriented.

Other methods for automated inspection of the orientation of a glass substrate can involve a number of options. For example, the first material that coats or impregnates the first side of the glass substrate can be tin. The sensor can be coupled with the automated lifting assembly. The automated lifting assembly can be used to position the glass substrate relative to the sensor so as to facilitate the inspection. The automated lifting assembly can be used to place the glass substrate on a storage rack in response to determining that the glass substrate is incorrectly oriented. The glass substrate can be reoriented on the storage rack. A quality control failure mode can be displayed in response to determining that a glass substrate is incorrectly oriented. A glass substrate removed from the conveyor in response to determining that the glass substrate was incorrectly oriented can be placed back on the conveyor in a correct orientation.

For a fuller understanding of the nature and advantages of the present invention, reference should be made to the ensuing detailed description and the accompanying drawings. Other aspects, objects and advantages of the invention will be apparent from the drawings and the detailed description that follows.

### BRIEF DESCRIPTION OF THE DRAWINGS

FIG. 1A is a cross-sectional schematic drawing of a glass substrate having material that coats and/or impregnates a side.

FIG. 1B is a cross-sectional schematic drawing of a glass substrate having a transparent conductive oxide (TCO) layer and a material that coats and/or impregnates a side.

FIG. 1C is a cross-sectional schematic drawing of a thin-film solar cell, showing the location and orientation of the front and back glass substrates.

FIG. 2 is a flow chart illustrating an embodiment of a method for automated inspection of the orientation of a glass substrate having a material that coats and/or impregnates a side.

FIG. 3 is a flow chart illustrating an embodiment of another method for automated inspection of the orientation of a glass substrate having a material that coats and/or impregnates a side.

FIG. 4 illustrates an exemplary tin surface detector, in accordance with embodiments.

FIG. 5 schematically illustrates the use of a robotic lifting assembly to position a glass sheet relative to a sensor, in accordance with embodiments.

FIG. 6 is a perspective illustration of a tin detector coupled with a production line conveyor, in accordance with embodiments.

FIG. 7 is a side view of a tin detector coupled with a production line conveyor, in accordance with embodiments.

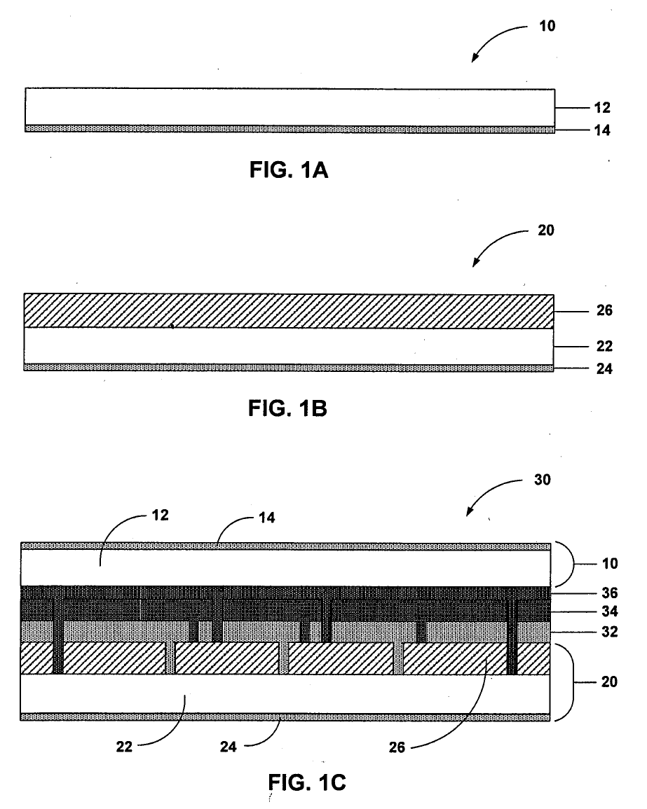

### DETAILED DESCRIPTION

In accordance with various aspects and embodiments of the invention described herein, methods are provided for automated inspection of the orientation of a glass substrate having a side that is coated and/or impregnated with a non-glass material, such as tin. Such methods can be particularly effective when used to ensure the orientation of tin coated and/or impregnated glass substrates used in the formation of some thin-film solar cells.

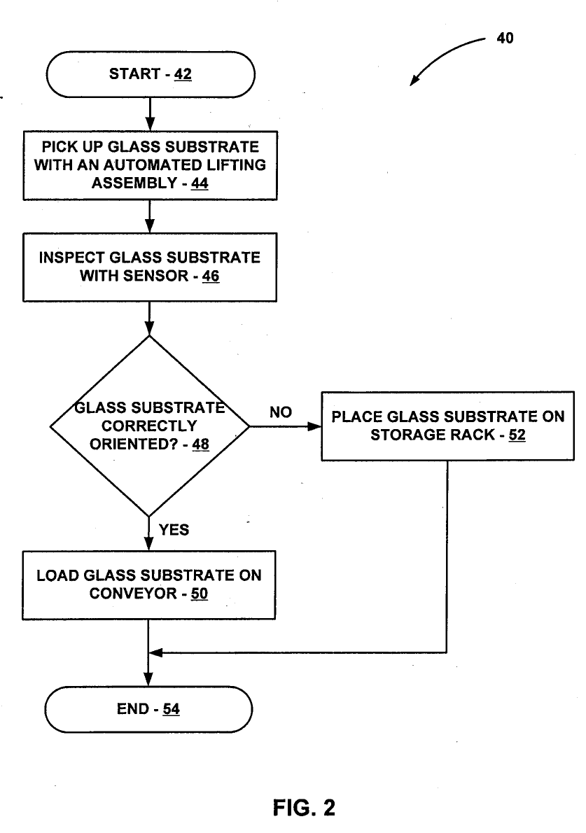

FIG. 2 is a flow chart illustrating a method 40, in accordance with an embodiment, for automated inspection of the orientation of a glass substrate having a material that coats and/or impregnates a side of the glass substrate. Method 40 can be used to ensure that such a glass substrate is properly oriented when it is placed on a production line conveyor, such as a conveyor used to transport glass substrate during the fabrication of thin-film solar cells. The process starts in operation 42 where the glass substrate is provided, such as in a storage rack containing one or more glass substrates. In operation 44, the glass substrate is picked up using an automated lifting assembly. Next, in operation 46 a side of the glass substrate is inspected with a sensor configured to detect the presence or absence of the applicable material that coats and/or impregnates a side of the glass substrate. For example, with a tin-coated glass substrate used in the fabrication of some thin-film solar cells, a tin sensor would be used. An exemplary tin sensor (Tin Surface Detector—Model 2002) is available from Glassline Corporation, 28905 Glenwood Road, P.O. Box 147, Perrysburg, Ohio 43552-0147 U.S.A. Based upon the inspection of operation 46, a determination is made in operation 48 as to whether the glass substrate is properly oriented. If the decision in operation 48 is that the glass substrate is properly oriented, then the glass substrate is loaded onto a production line conveyor in operation 50, thereby ending the application of the method to that particular glass substrate in operation 54. If the decision in operation 48 is that the glass substrate is not properly oriented, then the glass substrate is placed on a storage rack in operation 52.

Once the glass substrate is placed on the storage rack in operation 52, method 40 can include a number of optional operations. For example, the glass substrate that was placed on the storage rack in operation 52 can be reprocessed such that the glass substrate is subsequently picked up with the automated lifting assembly in operation 44 and re-inspected in operation 46 for possible loading onto the production line conveyor in operation 50. Alternatively, the glass substrate on the storage rack can be reoriented so as to be in the proper orientation when picked up by the automated lifting assembly in operation 44.

If one or more glass substrates that are picked up by the automated lifting assembly from a particular storage rack are found to be improperly oriented, the orientation of the remaining glass substrates on the storage rack may be suspect and another storage rack of glass substrates can be used instead. When a rack is determined to be suspect, a subsequent request for another storage rack can be made. Additionally, when one or more improperly oriented glass substrates are identified, a related quality control message can be displayed and/or communicated.

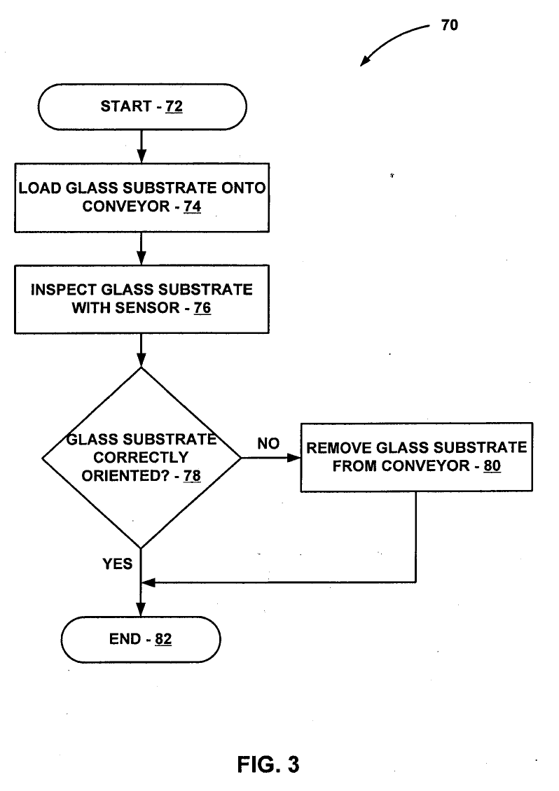

FIG. 3 is a flow chart illustrating a second method 70, in accordance with an embodiment, for automated inspection of the orientation of a glass substrate having a material that coats and/or impregnates a side of the glass substrate. Method 70 can be used to determine that such a glass substrate on a production line conveyor is properly oriented, such as a glass substrate that has been loaded on a production line conveyor used during the fabrication of thin-film solar cells. At the start of the process, in operation block 72 the glass substrate is provided, such as in a storage rack containing one or more glass substrates. In operation 74, the glass substrate is loaded onto a conveyor, such as a conveyor for a production line. Next in operation 76, a side of the glass substrate can be inspected with a sensor coupled with the conveyor and configured to detect the presence or absence of the applicable material that coats and/or impregnates a side of the glass substrate. For example, a sensor can be mounted so as to inspect a glass substrate as it passes along the conveyor, or a sensor can be mounted at a conveyor buffer station and the glass substrate can be forwarded to the buffer station for inspection. In operation 78, a determination is made whether the glass substrate is properly oriented on the conveyor. The inspection results from operation 76 can be used to make this determination. For example, if the glass substrate is a front glass for a thin-film solar cell, the tin side should be on the bottom side and if the glass substrate is a back glass for a thin-film solar cell, the tin side should be on the top side. If the glass substrate is determined to be properly oriented, no further action is necessary and the method ends in operation 82. However, if a glass substrate is determined to be incorrectly oriented, it can be removed from the conveyor in operation 80. A glass substrate that is removed from the conveyor can be reloaded onto the conveyor in the proper orientation. Related remedial actions can be taken, such as those optional actions discussed above with reference to FIG. 2.

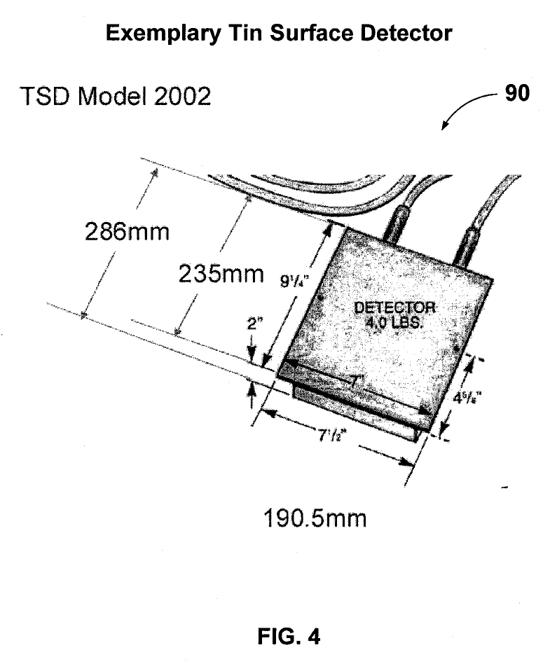

FIG. 4 shows dimensions and general configuration of an exemplary tin surface detector 90. Such a sensor can be mounted in a variety of ways for use in determining the orientation of a glass substrate. A tin surface detector can sample one or multiple points using a non-contact measurement. A measurement can be made anywhere on the surface without restriction. Once a measurement is made, a signal is sent back to an automation controller, which determines if the glass substrate is properly oriented. The signal can be a digital signal used to determine orientation based upon a pass/fail criteria.

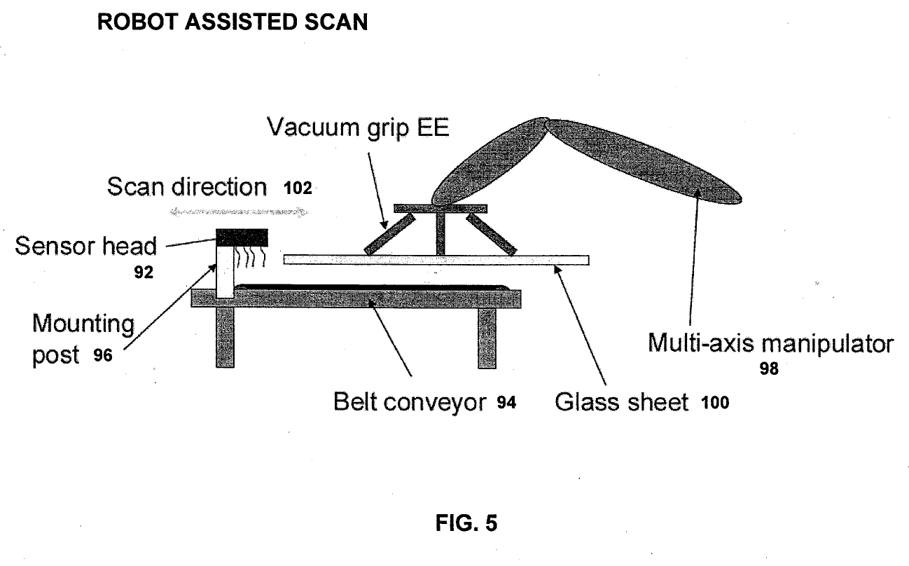

FIG. 5 illustrates one approach for mounting and utilizing a surface detection sensor, such as a tin surface detector. The sensor 92 is shown coupled with a belt conveyor 94 via a mounting post 96. A lifting assembly, such as the illustrated multi-axis manipulator 98, can be used to manipulate a glass substrate 100 along a scan direction 102 relative to the sensor 92. The sensor can also be coupled with the lifting assembly so as to be properly positioned relative to a glass substrate. Relative motion between the glass substrate and the sensor is not required. The scan results from the sensor 92 can then be used to determine the orientation of a glass substrate having a coated and/or impregnated side (e.g., a tin coated and/or impregnated side) and a non coated and/or impregnated side. Following a determination of proper orientation, the glass substrate can be placed on a conveyor, such as the belt conveyor shown, for a variety of purposes. For example, the conveyor can be part of a manufacturing line that incorporates the glass substrate into a product, or the conveyor can be part of a packaging line that packages the properly oriented glass substrate.

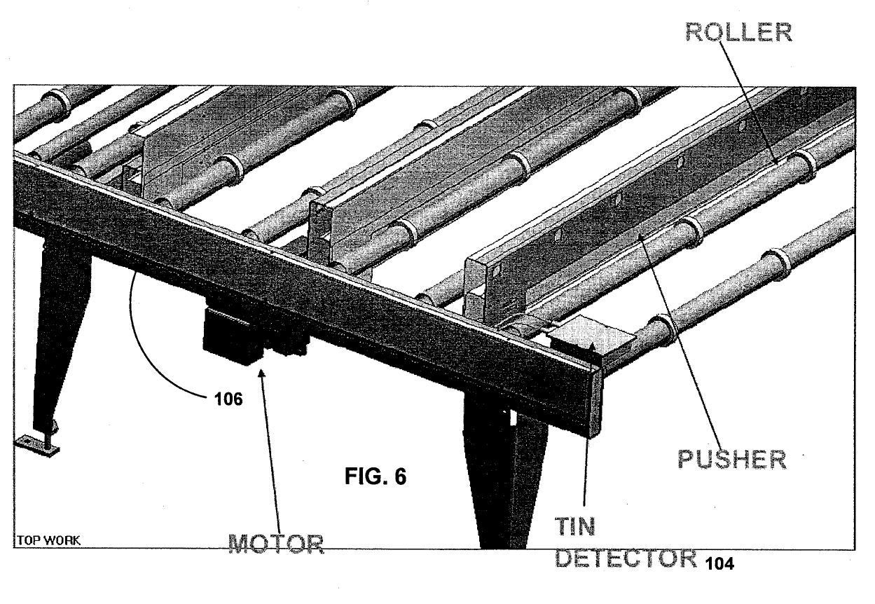

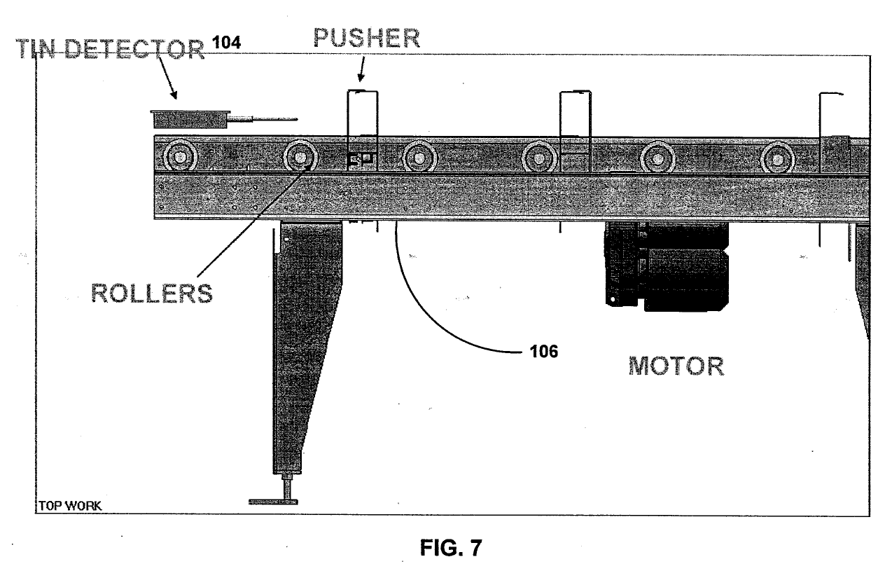

FIG. 6 shows a perspective view of a surface detection sensor 104 (e.g., a tin surface detection sensor) coupled with a conveyor 106 (structural coupling means not shown). Such an arrangement can be used to determine the orientation of a glass substrate on the conveyor when the glass substrate has a coated and/or impregnated side (e.g., a tin coated and/or impregnated side) and a non coated and/or impregnated side. If a glass substrate is identified as being incorrectly oriented, it can be removed from the conveyor. FIG. 7 illustrates a side view of the surface detection sensor 104 and conveyor 106 of FIG. 6, showing the surface detection sensor 104 being positioned so as to inspect the top surface of glass substrates on conveyor 106.

In one embodiment, a method of processing a glass substrate, wherein the glass substrate includes a first side and a second side and the first side of the glass substrate is coated or impregnated with a first material, the method includes picking up the glass substrate by using an automated lifting assembly, inspecting a side of the glass substrate with a sensor so as to determine whether the inspected side is the first side or the second side, determining whether the glass substrate is correctly oriented based upon whether the inspected side is the first side or the second side, and using the automated lifting assembly to place the glass substrate on a conveyor in response to determining that the glass substrate is correctly oriented. The first material can include tin. The sensor can also be coupled with the automated lifting assembly.

In another embodiment, that method further includes engaging the conveyor to transport the glass substrate to a subsequent tool for further processing in response to determining that the glass substrate is correctly oriented.

In yet another embodiment, that method further includes using the automated lifting assembly to position the glass substrate relative to the sensor so as to facilitate the inspection.

In yet another embodiment, that method further includes using the automated lifting assembly to place the glass substrate on a storage rack in response to determining that the glass substrate is incorrectly oriented. The method can further include reorienting the glass substrate on the storage rack. The method can also further include displaying a quality control failure mode in response to determining that a glass substrate is incorrectly oriented. Additionally, the method can further include identifying a batch from which the glass substrate originated and reorienting all glass substrates in the batch.

In another embodiment, a second method of processing a glass substrate, wherein the glass substrate includes a first side and a second side and the first side of the glass substrate is coated or impregnated with a first material, the method includes placing the glass substrate on a conveyor, inspecting a side of the glass substrate with a sensor so as to determine whether the inspected side is the first side or the second side, wherein the sensor is coupled with the conveyor, determining whether the glass substrate is correctly oriented based upon whether the inspected side is the first side or the second side, and removing the glass substrate from the conveyor in response to determining that the glass substrate is incorrectly oriented. The first material can include tin.

In yet another embodiment, the second method further includes placing the removed glass substrate back on the conveyor in a correct orientation.

In yet another embodiment, the second method further includes displaying a quality control failure mode in response to determining that a glass substrate is incorrectly oriented.

In yet another embodiment, the second method further includes engaging the conveyor to transport the glass substrate to a subsequent tool for further processing in response to determining that the glass substrate is correctly oriented. The second method can further include identifying a batch from which the glass substrate originated and reorienting all glass substrates in the batch.

In another embodiment, a system for processing a glass substrate, wherein the glass substrate includes a first side and a second side and the first side of the glass substrate is coated or impregnated with a first material, includes a conveyor for transporting the glass substrate, an automated lifting assembly to pick up the glass substrate, a sensor to inspect a side of the glass substrate, and a computer to determine whether the inspected side is the first side or the second side and to determine whether the glass substrate is correctly oriented based upon whether the inspected side is the first side or the second side. In one embodiment the sensor is stationary and coupled to the conveyor. In another embodiment, the sensor is moveable relative to the glass substrate.

It is understood that the examples and embodiments described herein are for illustrative purposes and that various modifications or changes in light thereof will be suggested to a person skilled in the art and are to be included within the spirit and purview of this application and the scope of the appended claims. Numerous different combinations are possible, and such combinations are considered to be part of the present invention.

What is claimed is:

1. A method of processing a glass substrate, wherein the glass substrate comprises a first side and a second side and the first side of the glass substrate is coated or impregnated with a first material, the method comprising:
picking up the glass substrate by using an automated lifting assembly;
inspecting a side of the glass substrate with a sensor so as to determine whether the inspected side is the first side or the second side;
determining whether the glass substrate is correctly oriented based upon whether the inspected side is the first side or the second side; and
using the automated lifting assembly to place the glass substrate on a conveyor in response to determining that the glass substrate is correctly oriented.

2. The method of claim 1, wherein the first material comprises tin.

3. The method of claim 1, further comprising engaging the conveyor to transport the glass substrate to a subsequent tool for further processing in response to determining that the glass substrate is correctly oriented.

4. The method of claim 1, wherein the sensor is coupled with the automated lifting assembly.

5. The method of claim 1, further comprising using the automated lifting assembly to position the glass substrate relative to the sensor so as to facilitate the inspection.

6. The method of claim 1, further comprising using the automated lifting assembly to place the glass substrate on a storage rack in response to determining that the glass substrate is incorrectly oriented.

7. The method of claim 6, further comprising reorienting the glass substrate on the storage rack.

8. The method of claim 6, further comprising displaying a quality control failure mode in response to determining that a glass substrate is incorrectly oriented.

9. The method of claim 6, further comprising identifying a batch from which the glass substrate originated and reorienting all glass substrates in the batch.

10. A method of processing a glass substrate, wherein the glass substrate comprises a first side and a second side and the first side of the glass substrate is coated or impregnated with a first material, the method comprising:
placing the glass substrate on a conveyor;
inspecting a side of the glass substrate with a sensor so as to determine whether the inspected side is the first side or the second side, wherein the sensor is coupled with the conveyor;
determining whether the glass substrate is correctly oriented based upon whether the inspected side is the first side or the second side; and
removing the glass substrate from the conveyor in response to determining that the glass substrate is incorrectly oriented.

11. The method of claim 10, further comprising placing the removed glass substrate back on the conveyor in a correct orientation.

12. The method of claim 10, wherein the first material comprises tin.

13. The method of claim 10, further comprising displaying a quality control failure mode in response to determining that a glass substrate is incorrectly oriented.

14. The method of claim 10, further comprising engaging the conveyor to transport the glass substrate to a subsequent tool for further processing in response to determining that the glass substrate is correctly oriented.

15. The method of claim 10, further comprising identifying a batch from which the glass substrate originated and reorienting all glass substrates in the batch.

16. A system for processing a glass substrate, wherein the glass substrate comprises a first side and a second side and the first side of the glass substrate is coated or impregnated with a first material, comprising:
a conveyor for transporting the glass substrate;
an automated lifting assembly to pick up the glass substrate;
a sensor to inspect a side of the glass substrate; and
a computer to determine whether the inspected side is the first side or the second side and to determining whether the glass substrate is correctly oriented based upon whether the inspected side is the first side or the second side.

17. The system of claim 16 wherein the sensor is stationary and coupled to the conveyor.

18. The system of claim 16 wherein the sensor is moveable relative to the glass substrate.
